(19) United States
(12) Patent Application Publication
(10) Pub. No.: US 2011/0199491 A1
(43) Pub. Date: Aug. 18, 2011

(54) CALIBRATION INDEX DETERMINATION DEVICE, CALIBRATION DEVICE, CALIBRATION PERFORMANCE EVALUATION DEVICE, SYSTEM, METHOD, AND PROGRAM

(76) Inventors: Takashi Jikihira, Tokyo (JP); Junichi Funada, Tokyo (JP)

(21) Appl. No.: 13/123,941

(22) PCT Filed: Oct. 23, 2009
(86) PCT No.: PCT/JP2009/068257

§ 371 Date: Apr. 13, 2011

(30) Foreign Application Priority Data
Oct. 28, 2008 (JP) 2008-276675

(51) Int. Cl. H04N 17/00

(52) U.S. Cl. 348/188; 348/E17.002

(57) ABSTRACT

Disclosed is a system to determine whether calibration indices are appropriate for each camera when calibrating large quantities of cameras, in which there is great variation in individual differences in image blurring characteristics. The present invention takes an image of a calibration index and calculates the calibration precision that can be expected in calibration from the calibration index image that has been taken. If the calibration precision that can be expected is not optimal for each camera, the density of lines or shapes that constitute the calibration index is changed until the optimum calibration index for each camera is found.

### TECHNICAL FIELD

The present invention relates to a technique for determining a calibration index for use in calibrating distortion in a captured image.

### BACKGROUND ART

Several kinds of camera calibrating apparatuses for calibrating distortion in an image obtained by image capture have been proposed.

According to Patent Literatures 1 and 2, an apparatus of this kind is comprised of: a calibration index display for displaying a calibration index having a uniform grid point density; an imaging section for imaging the calibration index being displayed on the calibration index display to acquire the calibration index as an image; a correct position acquiring section for acquiring correct positions of all lines or figures constituting the calibration index displayed on the calibration index display; and a calibration parameter calculator for calculating parameters for calibrating distortion in the captured image using positions in the image of lines or figures constituting the calibration index on the image obtained from the imaging section and the correct calibration positions obtained from the correct position acquiring section.

The calibrating system having such a configuration operates as follows:

First, a calibration index being displayed on the calibration index display is imaged by the imaging section. Next, based on information on positions of lines or figures constituting the calibration index obtained from the captured calibration index image and information on positions of lines or figures constituting the calibration index obtained by the correct position acquiring section, parameters for calibrating distortion in the captured image arc calculated by the calibration parameter calculator.

According to Patent Literature 3, an apparatus of the kind described above is comprised of: a calibration index display capable of changing the grid point density depending upon distortion in a captured image; an imaging section for imaging the calibration index being displayed on the calibration index display to acquire the calibration index as an image; a distortion deciding section for deciding the presence of distortion in the captured image from distances between lines or figures constituting the calibration index on the image obtained from the imaging section; an index display controller for controlling the calibration index display to raise the density of the lines or figures constituting the calibration index in a sub-region in the calibration index image decided to have distortion by the distortion deciding section; a correct position acquiring section for acquiring positions of lines or figures constituting a calibration index to be obtained after calibrating distortion in the calibration index being displayed on the calibration index display; and a calibration parameter calculator for calculating parameters for calibrating distortion in the captured image using positions in the image of lines or figures constituting the calibration index on the captured calibration index image obtained from the imaging section, and correct calibration positions obtained from the correct position acquiring section. The calibrating system having such a configuration operates as follows:

First, a calibration index being displayed on the calibration index display is imaged by the imaging section. Next, the presence of distortion in the captured calibration index image is detected by the distortion deciding section using the captured calibration index image, and in a case that there is found a region decided to have distortion in the calibration index image, the density of lines or figures constituting the calibration index within the region is raised by the index display controller. Thereafter, the calibration index is imaged again by the imaging section, and based on pre-calibrated positions of lines or figures constituting the calibration index on the captured calibration index image, and information on positions of lines or figures constituting the calibration index to be obtained after calibration acquired by the correct position acquiring section, parameters for calibrating distortion in the captured image arc calculated by the calibration parameter calculator.

### [Citation List]

[Patent Literature]

PTL 1: JP-P2008-92602A

PTL 2: JP-P2007-292619A

PTL 3: JP-P2008-70347A

[Non Patent Literature]

NPL 1: “Textbook of Algorithms—Fundamentals and Applications of Algorithms Illustrated by Practical Programs,” written by Naoki MIKAMI, published by CQ Publishing Co., Ltd., 1996

### DISCLOSURE OF INVENTION

### Technical Problem

The aforementioned calibrating systems, however, do not use calibration indices suitable for individual cameras, which fact poses the following problems in calibrating a large number of cameras having a wide range of variation of individual differences in image unsharpness property.

According to PTLs 1 and 2, the techniques as described above generally provide calibration accuracy improved more for a larger number of figures constituting a calibration index.

On the other hand, since the area covered by a camera is limited; the size of a figure becomes smaller for a larger number of figures on an image, as a matter of course. A figure having a size smaller than the size of one pixel cannot be sharply imaged, which makes it impossible to acquire the position of the figure. In other words, when too many figures are used for the purpose of improving calibration accuracy, the figures constituting the calibration index cannot be acquired in themselves.

Moreover, for cameras experiencing blurring, which is image unsharpness caused by optical problems, figures may not be sharply captured depending upon the degree of blurring, resulting in a problem that dots of small figures lying at positions suffering from strong blurring cannot be sharply observed. Especially for partial blurring, an effect of partial unsharpness in a calibration index image due to blurring results in poor calibration accuracy in a portion suffering from blurring.

In contrast, according to PTL 3, a configuration capable of partially modifying the density of figures constituting a calibration index is employed, rather than limiting the density of figures constituting a calibration index to a constant value. In this configuration, however, no mention is made of an upper limit in modifying the density of figures. In other words, a tradeoff between sharpness and the number of lines or figures constituting the calibration index is not considered.

Especially for partial blurring whose property varies from camera to camera, it is indeed difficult to perform calibration with good accuracy because the upper limit of the density of figures is not considered.

It is therefore an object of the present invention to provide a technique for, especially for a large number of cameras having a wide range of variation of individual differences in blurring property, evaluating whether a calibration index is suitable for each camera, and determining a most suitable calibration index.

### Solution to Problem

An aspect of the present invention for solving the aforementioned problem is a calibration index determining apparatus characterized in comprising determiner for providing an evaluation of each calibration index based on a resolution of each calibration index image obtained by imaging a plurality of calibration indices, each composed of at least lines or figures and each having a different size or density of said lines or figures, and determining any one of the calibration indices based on a result of the evaluation.

Another aspect of the present invention for solving the aforementioned problem is a calibrating apparatus characterized in comprising calibration parameter calculator for calculating distortion calibration parameters based on positions of lines or figures in a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration indices, and positions of lines or figures in a calibration index on a calibration index image obtained by imaging said determined calibration index.

A still another aspect of the present invention for solving the aforementioned problem is a calibration performance evaluating apparatus characterized in comprising calibration performance evaluating section for evaluating accuracy in distortion correction based on positions of lines or figures constituting a calibration index image corrected using a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration indices, and positions of lines or figures constituting said determined calibration index.

A still another aspect of the present invention for solving the aforementioned problem is a calibration index determining system characterized in comprising determiner for providing an evaluation of each calibration index based on a resolution of each calibration index image obtained by imaging a plurality of calibration indices, each composed of at least lines or figures and each having a different size or density of said lines or figures, and determining any one of the calibration indices based on a result of the evaluation.

A still another aspect of the present invention for solving the aforementioned problem is a calibration index determining method, characterized in comprising steps of: providing an evaluation of each calibration index based on a resolution of each calibration index image obtained by imaging a plurality of calibration indices, each composed of at least lines or figures and each having a different size or density of said lines or figures; and determining any one of the calibration indices based on a result of said evaluation:

A still another aspect of the present invention for solving the aforementioned problem is a program characterized in causing a calibration index evaluating apparatus to execute processing of providing an evaluation of each calibration index based on a resolution of each calibration index image obtained by imaging a plurality of calibration indices, each composed of at least lines or figures and each having a different size or density of said lines or figures, and determining any one of the calibration indices based on a result of the evaluation.

A still another aspect of the present invention for solving the aforementioned problem is a program characterized in causing a calibrating apparatus to execute processing of calculating distortion calibration parameters based on positions of lines or figures in a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration indices, and positions of lines or figures in a calibration index on a calibration index image obtained by imaging said determined calibration index.

A still another aspect of the present invention for solving the aforementioned problem is a program characterized in causing a calibration performance evaluating apparatus to execute processing of evaluating accuracy in distortion correction based on positions of lines or figures constituting a calibration index image corrected using a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration index, and positions of lines or figures constituting said determined calibration index.

### ADVANTAGEOUS EFFECTS OF INVENTION

According to the present invention, especially for a large number of cameras having a wide range of variation of individual differences in image unsharpness property, a calibration index suitable for each camera can be determined.

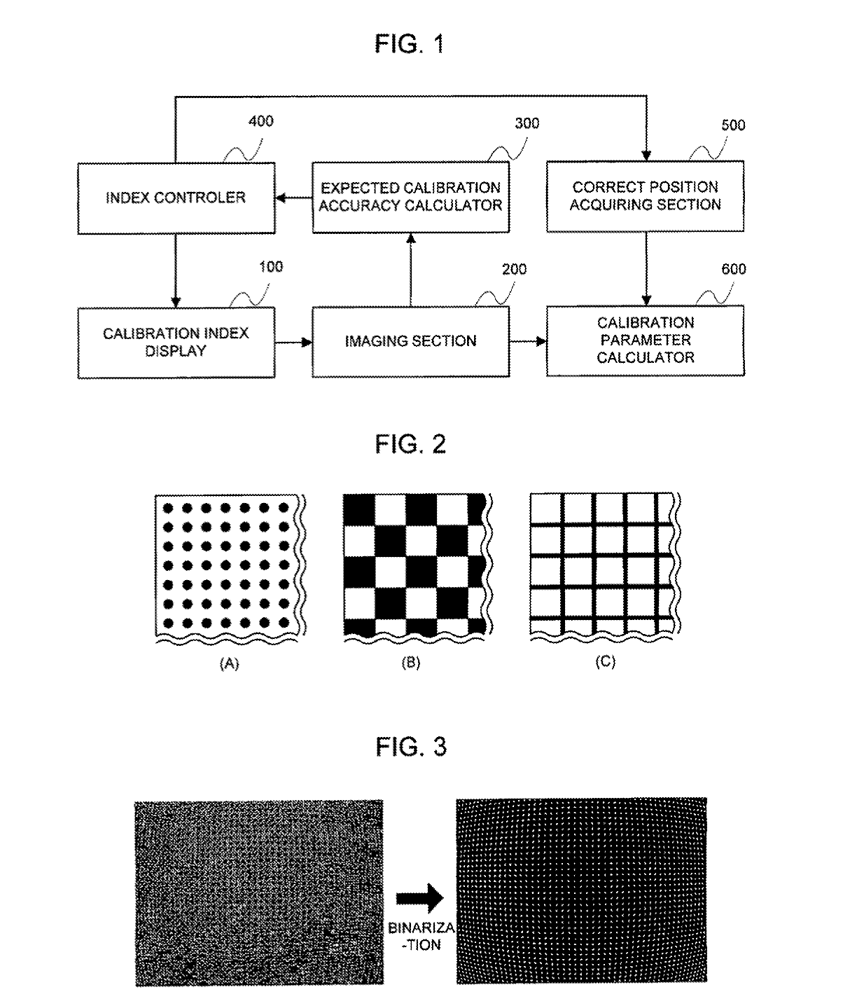

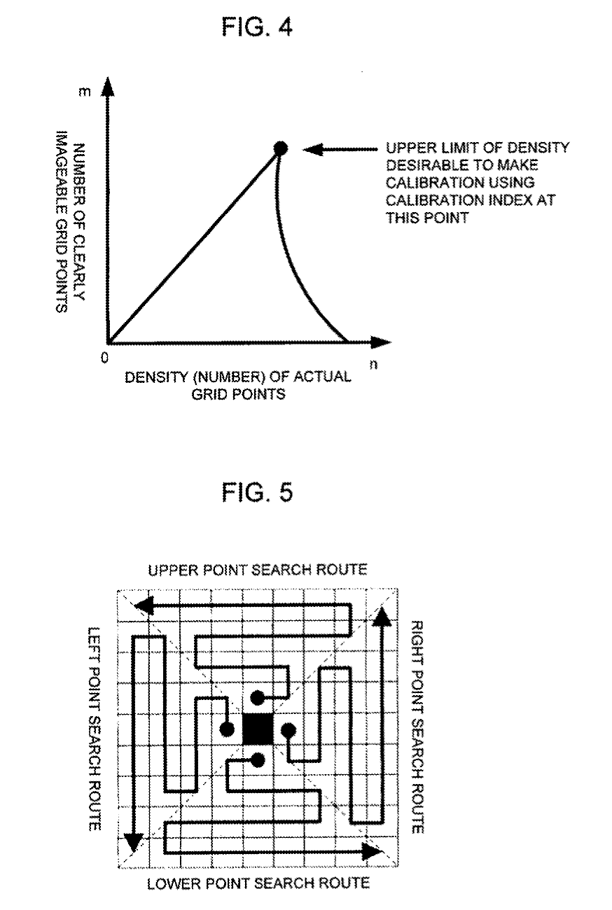

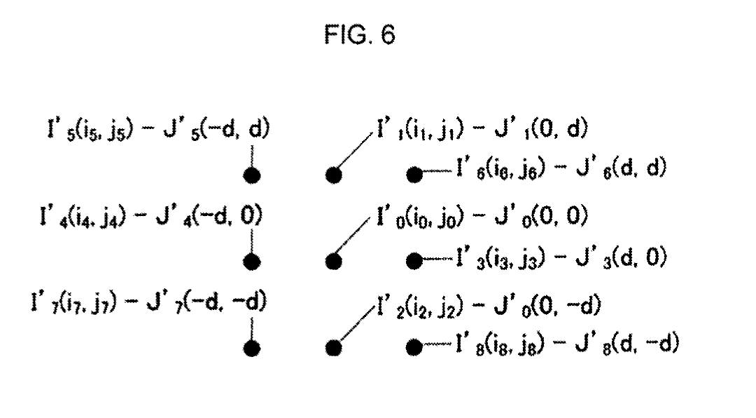

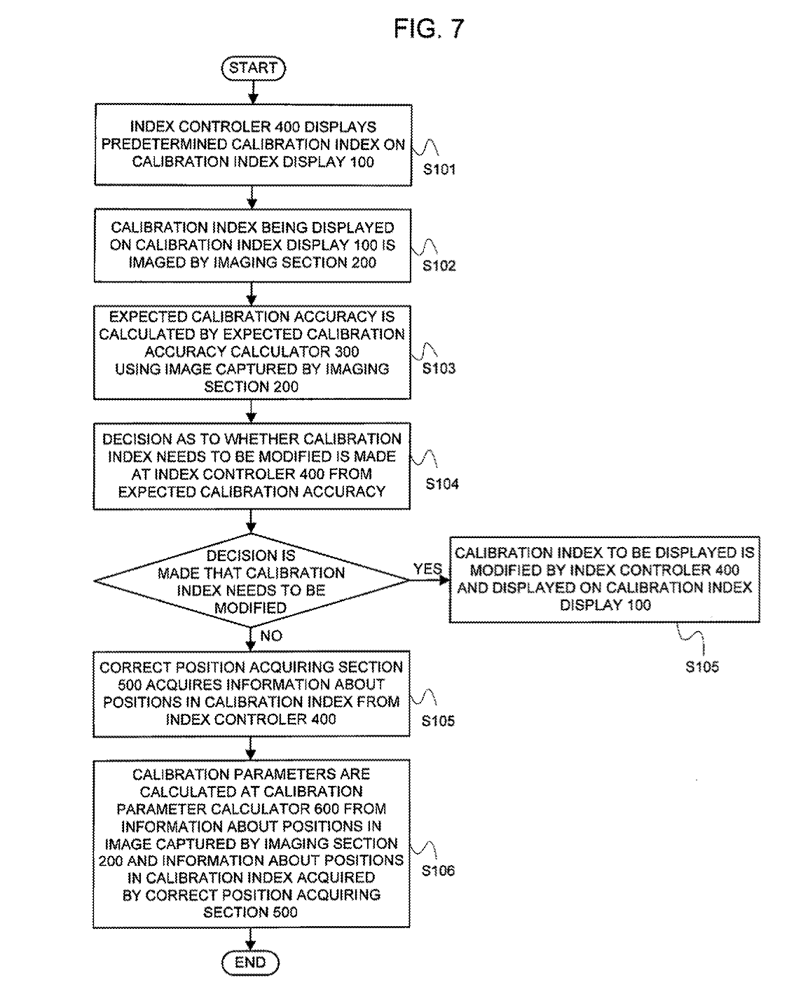

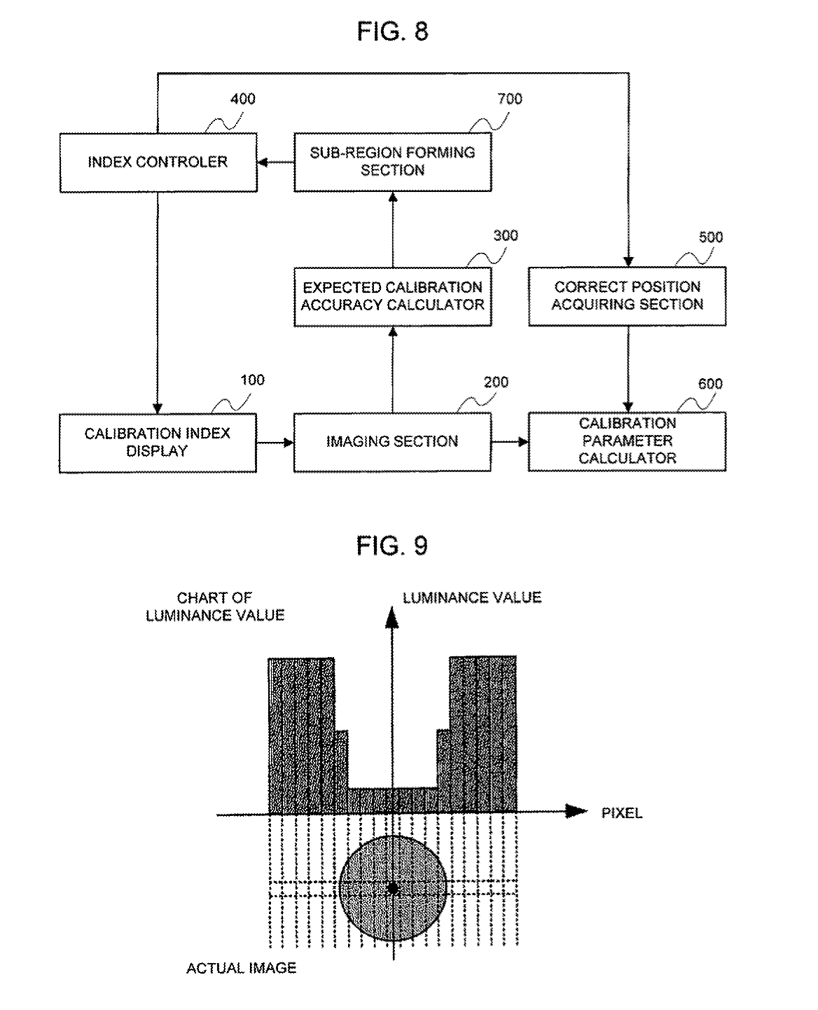

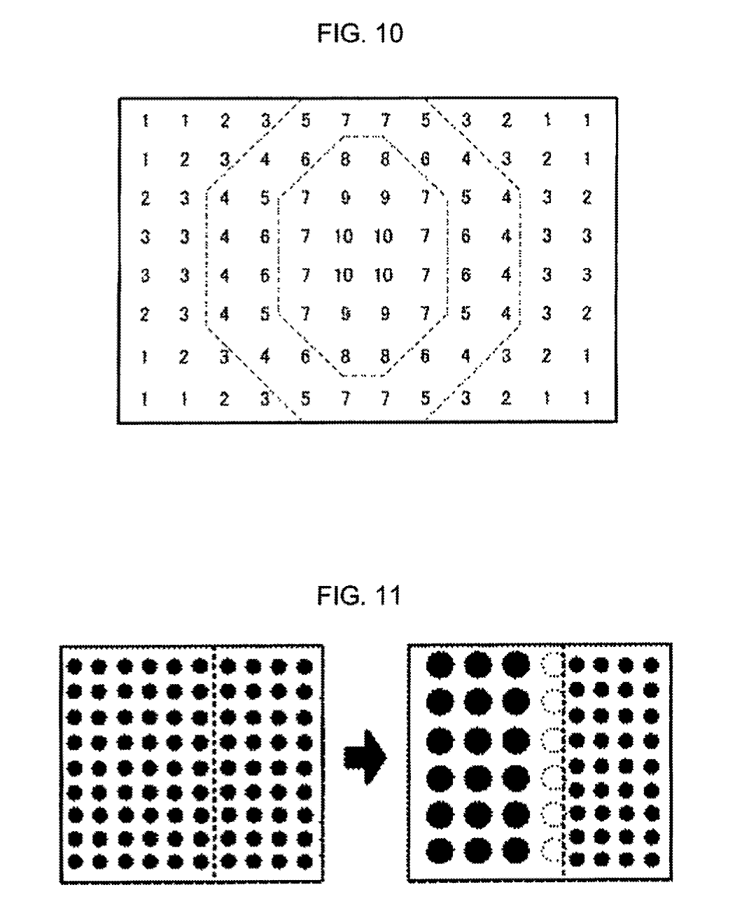

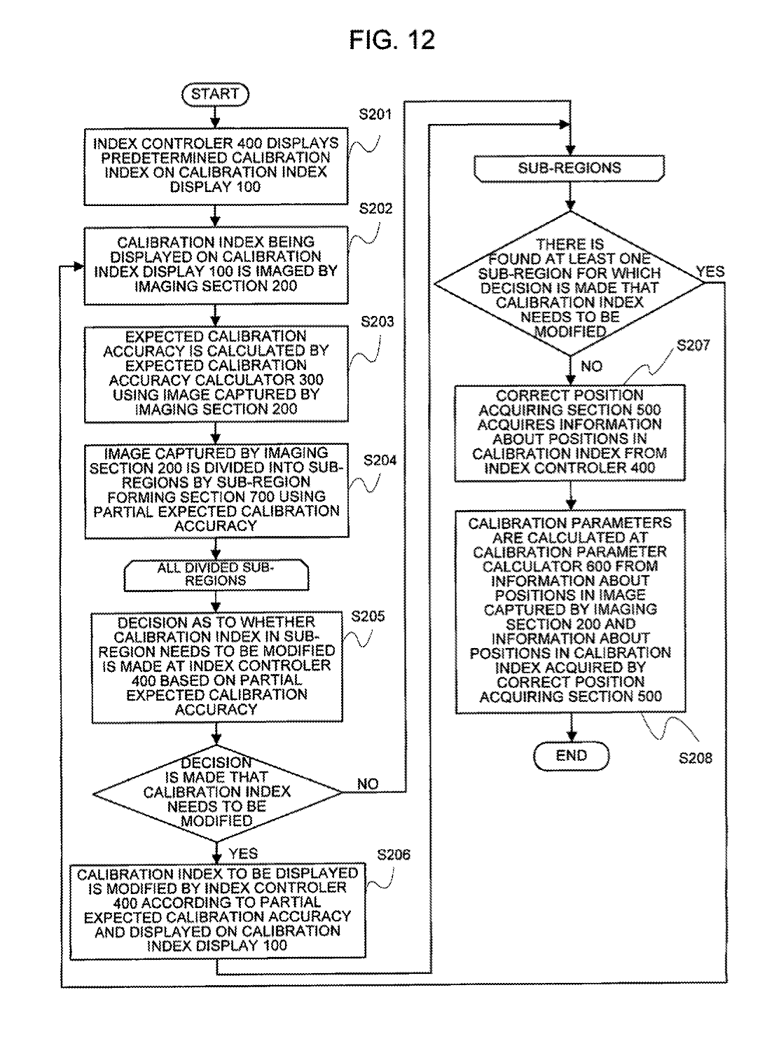

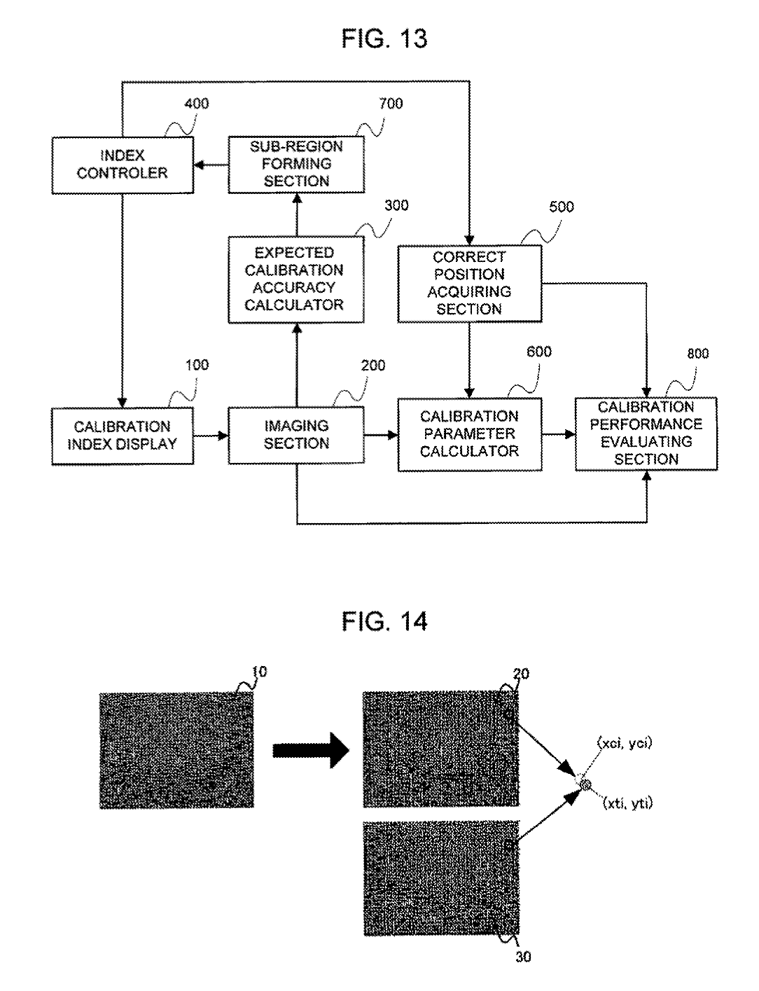

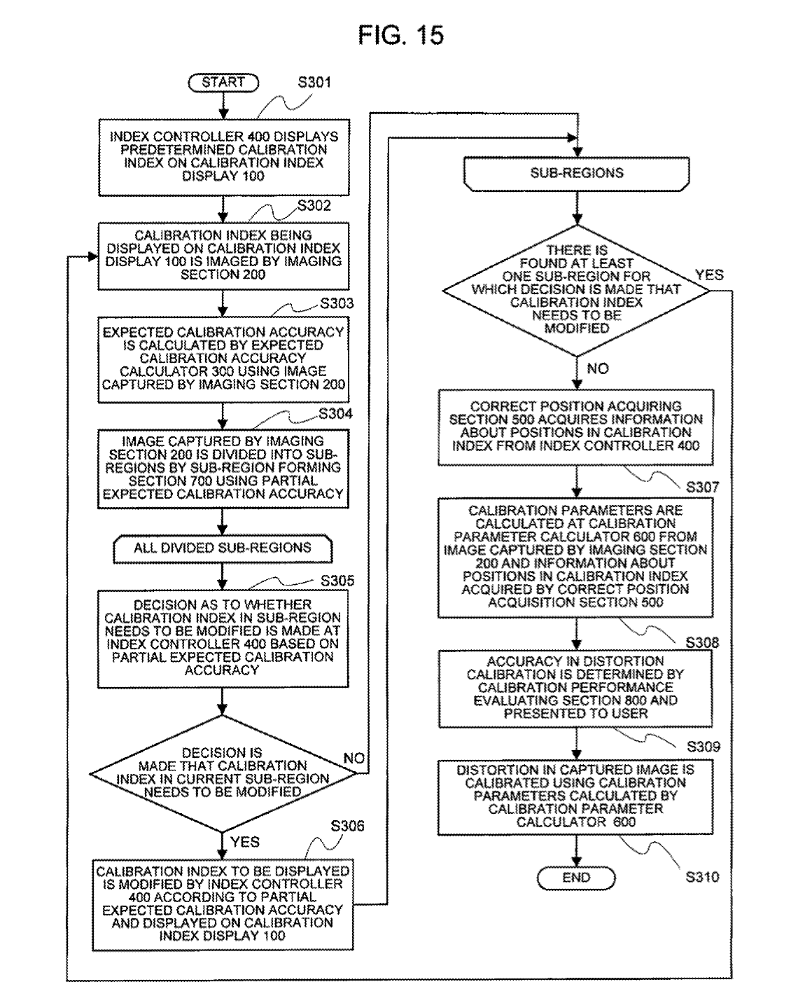

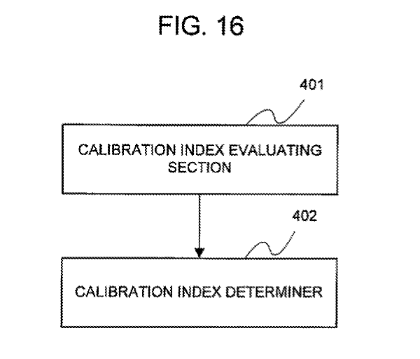

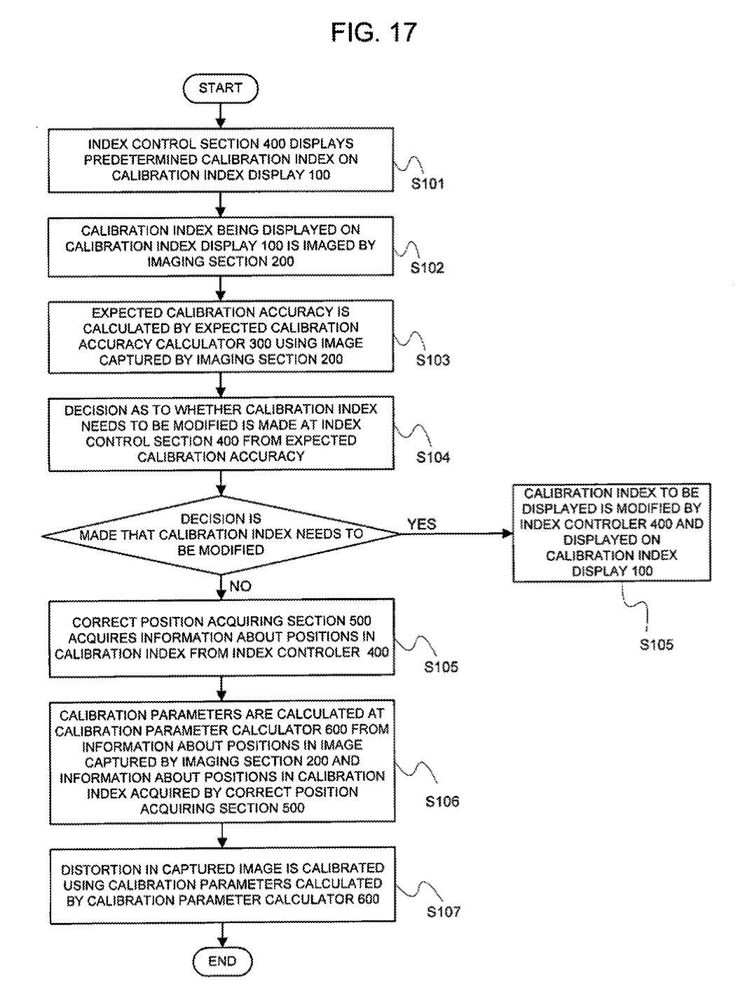

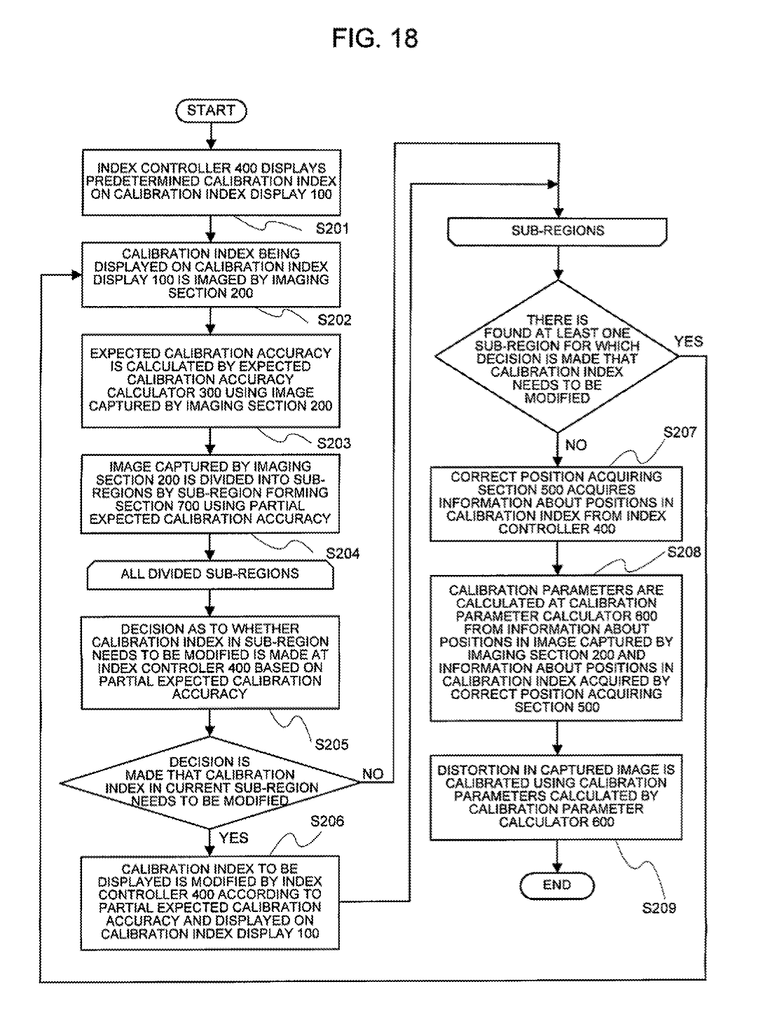

### BRIEF DESCRIPTION OF DRAWINGS

[FIG. 1] A block diagram for explaining a configuration of a calibrating system in a first embodiment of the present invention.

[FIG. 2] A diagram for explaining examples of a calibration index displayed on a calibration index display in the first embodiment of the present invention.

[FIG. 3] A diagram for explaining an example of processing at an expected calibration accuracy calculator in the first embodiment of the present invention.

[FIG. 4] A diagram for explaining a numerical relationship between the number of actual grid points and the number of clearly imageable grid points in the first embodiment of the present invention.

[FIG. 5] A diagram for explaining a manner of point search for grid points in the first embodiment of the present invention.

[FIG. 6] A diagram for explaining association of grid points in the first embodiment of the present invention.

[FIG. 7] A flow chart for explaining an operation of the calibrating system in the first embodiment of the present invention.

[FIG. 8] A block diagram for explaining a configuration of a calibrating system in a second embodiment of the present invention.

[FIG. 9] A diagram for explaining an example of calculation of a partial expected calibration accuracy in the second embodiment of the present invention.

[FIG. 10] A diagram for explaining an example of processing of dividing into sub-regions based on the partial expected calibration accuracy in the second embodiment of the present invention.

[FIG. 11] A diagram for explaining display of a calibration index based on the expected calibration accuracy in the second embodiment of the present invention.

[FIG. 12] A flow chart for explaining an operation of the calibrating system in the second embodiment of the present invention.

[FIG. 13] A block diagram for explaining a configuration of a calibrating system in a third embodiment of the present invention.

[FIG. 14] A diagram for explaining an example of calculation of calibration performance in the third embodiment of the present invention.

[FIG. 15] A flow chart for explaining an operation of a calibration index evaluating apparatus in the third embodiment of the present invention.

[FIG. 16] A block diagram of a calibration index determining apparatus in accordance with the present invention.

[FIG. 17] A flow chart for explaining an operation of camera calibration in the first embodiment of the present invention.

[FIG. 18] A flow chart for explaining an operation of camera calibration in the second embodiment of the present invention.

### DESCRIPTION OF EMBODIMENTS

Now several embodiments of the present invention will be described with reference to the accompanying drawings.

### First Embodiment

A configuration of a calibrating system in accordance with the present embodiment is shown in FIG. 1.

The calibrating system is a system for calibrating distortion in a captured image caused by the property of a lens or performance of an imaging device, and is configured to have a calibration index display 100, an imaging section 200, an expected calibration accuracy calculator 300, an index controller 400, a correct position acquiring section 500, a calibration parameter calculator 600, and a calibrating section 900.

The calibration index display 100 is controlled by the index controller 400 to display a calibration index for the imaging section 200, which is an object of distortion calibration. The calibration index display 100 may be a display device, a projector apparatus or an electric-light signboard, for example, connected with a computer comprised of a central processing unit (CPU) and storage devices (ROM, RAM, HDD, etc.). Moreover, the calibration index to be displayed may be any one of several kinds of figures disposed over grid points (FIG. 2A), for example, or alternatively, a checker pattern (FIG. 2B) or a rectilinear grid (FIG. 2C).

The imaging section 200 images a calibration index being displayed on the calibration index display 100. The imaging entity may be a camera itself, for example, for which distortion is to be calibrated.

The expected calibration accuracy calculator 300 calculates an expected calibration accuracy representing a degree of suitability of the calibration index being displayed on the calibration index display 100 to the imaging section 200 from the resolution of a calibration index image captured by the imaging section 200. The expected calibration accuracy calculator 300 has a calibration index image captured by the imaging section 200 as input, and may be configured by cooperation of predetermined programs and the like stored in a storage device in a computer comprised of a central processing unit (CPU) and storage devices (ROM, RAM, HDD, etc.).

In such a configuration, the expected calibration accuracy is for representing a degree of suitability of a calibration index in calibrating distortion in a captured image, wherein a resolution lowered for a higher density of lines or figures constituting the calibration index is considered as a factor affecting calibration parameters, and the expected calibration accuracy may be defined by, for example, applying binarization to the image obtained by the imaging section 200 (FIG. 3), and regarding the number of regions of interest (figures) that can be clearly extracted from the binarized image as the expected calibration accuracy. Alternatively, the expected calibration accuracy may be defined as a variance of grayscale values of pixels in the image obtained by the imaging section 200, or defined by applying edge detection processing to the image obtained by the imaging section 200 using a Sobel operator, a Laplacian operator or the like, and regarding an average of the edge intensity in regions detected as an edge as the expected calibration accuracy. Moreover, the expected calibration accuracy may be defined by acquiring, by appropriate image processing, an angle representing the orientation of an edge, a variance of color elements at each pixel of the image, or the number, size or line thickness of figures constituting the calibration index, and regarding such a value as the expected calibration accuracy. Further, these kinds of processing may be executed in parallel to calculate the expected calibration accuracy as multi-dimensional information in which results of the processing are combined, or an evaluation function parameterized by results of the processing may be defined beforehand and an evaluation value from the evaluation function may be regarded as the expected calibration accuracy.

The index controller 400 evaluates whether the calibration index being displayed on the calibration index display 100 needs to be modified from the expected calibration accuracy calculated by the expected calibration accuracy calculator 300, and in a case that a decision is made that the calibration index being displayed on the calibration index display 100 needs to be modified, it modifies the size or density of lines or figures constituting the calibration index being displayed on the calibration index display 100 according to the expected calibration accuracy calculated by the expected calibration accuracy calculator 300, and displays a newly generated calibration index on the calibration index display 100. On the other hand, in a case that a decision is made that the calibration index being displayed on the calibration index display 100 does not need to be modified, the index controller 400 displays a calibration index displayed before the last modified calibration index on the calibration index display 100.

The index controller 400 has the calibration index display 100 as output, for example, and may be configured by cooperation of predetermined programs and the like stored in a storage device in a computer comprised of a central processing unit (CPU) and storage devices (ROM, RAM, HDD, etc.).

In such a configuration, assuming that the expected calibration accuracy calculated by the expected calibration accuracy calculator 300 is defined as the number of regions of interest that can be clearly extracted from the binarized image, for example, and representing the expected calibration accuracy before the immediately preceding one as m(t−2), the immediately preceding expected calibration accuracy as m(t−1), and the current expected calibration accuracy as m(t), a decision may be made that the calibration index needs to be modified in a case that EQ. (1) below is satisfied, or otherwise, that it does not need to be modified.

m(t−1)−m(t−2)>0 Λm(t)−m(t−1)>0 EQ. (1)

The reason why EQ. (1) above is served as a criterion of decision is as follows:

For example, denoting the number of figures on grid points actually displayed on the calibration index display as n, and the number of figures on grid points obtained from a calibration index image resulting from binarization of a captured calibration index image as m following the expression in EQ. (1), the relationship between n and m may be generally represented as shown in FIG. 4.

The size of figures is decreased for a larger number of the figures as a matter of course, and in due course, distinction between the figures and background becomes unclear due to quantization in imaging by a camera. That is, because of a limit of resolution, figures cannot be recognized as regions of interest in the binarizing processing.

Thus, while the number of figures is lower, the number of resulting regions of interest increases as the number of figures is increased. However, as soon as the number of figures has reached a certain value or higher, the number of resulting regions takes a downward turn. A point immediately before the number of resulting regions of interest takes a downward turn shows that the number of figures is maximized while keeping sharpness of the figures, and EQ. (1) is a formula that detects this point of inflection.

When a decision is made that the calibration index needs to be modified, and assuming that the calibration index comprises grid points, for example, the calibration index may be modified by increasing the density so that the total number of grid points is increased by reducing the diameter of each grid point and decreasing the distance between grid points.

The calibration index displayed here at the start of calibration desirably has a number of grid points as small as possible.

A method of modifying the density of lines or figures constituting a calibration index so that the total number of grid points is increased will now be specifically described hereinbelow.

When the diameter of a grid point is represented as d, the distance between end points of grid points is determined as d/2. Assuming that the calibration index is rectangular, and representing its height as h and its width as w, and the diameter of a grid point before modifying the calibration index as d(t−1), the number of grid points n(t−1) displayed before modifying the calibration index is given by EQ. (2) below:

n(t−1)=[2w/3d(t−1)]×[2h/3d(t−1)] EQ. (2)

where [k] represents an integer not exceeding k (Gauss symbol).

Likewise, representing the diameter of a grid point after modifying the calibration index as d(t), the number of grid points n(t) displayed after modifying the calibration index is given by EQ. (3) below:

n(t)=[2w/3d(t)]×[2h/3d(t)] EQ. (3)

To modify the calibration index so that the number of grid points is increased, one d(t) that satisfies EQ. (4) given below may be determined. By using the thus-calculated diameter of a grid point to calculate a distance between end points of grid points, and putting grid points at intervals of the distance between end points of grid points, a modified calibration index can be determined.

n(t)−n(t−1)>0 EQ. (4)

A method of determining d(t) may involve first defining d(t) as a value of d(t−1) decremented by one, evaluating the result as to whether it satisfies EQ. (4), and in a case that it satisfies EQ. (4), defining the value as d(t), or otherwise, defining d(t) as a value further decremented by one for repetitive evaluation.

The positions of centers of grid points may be defined by considering a calibration index to be rectangular and a coordinate system to have coordinates with an upper-right end point of the calibration index as an origin and right and lower directions as positive, and defining centers of grid points to be drawn at (3d(t)i/2+3d(t)/2, 3d(t)j/2+3d(t)/2), wherein i=0, 1, 2, . . . , and j=0, 1, 2, . . . in this coordinate system.

On the other hand, when a decision is made that the calibration index does not need to be modified, a calibration index before the last modification is displayed on the calibration index display 100.

Alternatively, the criterion of decision as to whether the calibration index should be modified may include a decision as to whether or not the variance of grayscale values of pixels in a captured image is equal to or greater than a certain value, a decision as to whether or not the average of edge intensity by any one of edge detection operators is equal to or greater than a certain value, and a decision as to whether or not the orientation of an edge, the color information, or the number, size or line thickness of figures constituting the calibration index is equal to or greater than a threshold. Moreover, a multi-dimensional vector may be defined to have at least one image feature such as the orientation of an edge or color information listed here as its elements, and the criterion may be a decision as to whether or not the norm or scalar product of the vector satisfies a certain condition, or a decision as to whether or not an evaluation value from an evaluation function for comprehensively evaluating calibration quality falls within a predefined range.

Methods of modifying the calibration index may include ones suitable for the geometry of the calibration index, such as a method of modifying the length or area of a unit figure constituting the calibration index, a method of modifying the thickness of lines constituting the calibration index, and the like.

Likewise, for a calibration index of a rectilinear grid, a modified calibration index may be determined by calculating a length of a side of a grid when EQ. (4) having the length of the side of the grid defined as d(t) is satisfied, putting points at intervals of the calculated length of the side of the grid, and joining the points in vertical and horizontal directions to create a rectilinear grid.

For a calibration index of a checker pattern, a modified calibration index may be determined by calculating a length of a side of a square cell when EQ. (4) having the length of the side of the square cell defined as d(t) is satisfied, and alternately disposing at least four square cells comprising black ones and white ones in horizontal and vertical directions, each square cell having the calculated length of the side.

The correct position acquiring section 500 acquires information on positions of lines or figures constituting the calibration index being displayed on the calibration index display 100.

For example, the correct position acquiring section 500 has information on coordinates or the like of figures or lines constituting the calibration index determined by the index controller 400 as input, and may be configured by cooperation of predetermined programs and the like stored in a storage device in a computer comprised of a central processing unit (CPU) and storage devices (ROM, RAM, HDD, etc.).

In such a configuration, assuming that figures constituting the calibration index are grid points, for example, the distance between end points of grid points calculated by the index controller 400 may be acquired. Moreover, coordinates of centers of grid points, or coordinates of positions of grid points transformed into those in a coordinate system of the imaging section 200 may be acquired. Alternatively, information suitable for the geometry of a calibration index may be acquired.

The calibration parameter calculator 600 calculates parameters for calibrating distortion in the captured image from information on positions of lines or figures in the calibration index image captured by the imaging section 200 and information on positions of lines or figures in the calibration index being displayed on the calibration index display 100 acquired by the correct position acquiring section 500.

For example, the calibration parameter calculator 600 has information on positions of lines or figures in a calibration index image captured by the imaging section 200, and information on positions of lines or figures in the calibration index being displayed on the calibration index display 100 acquired by the correct position acquiring section 500 as input. The calibration parameter calculator 600 may be configured by cooperation of predetermined programs and the like stored in a storage device in a computer comprised of a central processing unit (CPU) and storage devices (ROM, RAM, HDD, etc.).

In such a configuration, one specific method of calculating parameters for calibrating distortion is as follows.

For example, assume that figures constituting a calibration index are grid points, and information acquired by the correct position acquiring section 500 is the distance between end points of grid points. The calibration parameter calculator first applies binarization and labeling processing to the calibration index image captured by the imaging section 200, and acquires positions of centers Ik=(ik, jk) of extracted regions of interest, where k=1, 2, . . . , n, and n is the total number of extracted regions of interest.

Next, positions of centers of regions of interest in the calibration index being displayed on the calibration index display 100 are determined. First, assume that one of the points Ik that is closest to the center of the image is represented as Im, and positions of centers of extracted regions of interest in a coordinate system with an origin lying at Im are defined as I′k=(xk, yk) (k=1, 2, . . . n).

Next, vertically and horizontally adjacent center points of regions of interest are searched for from the origin. A method of the search is based on search routes as shown in FIG. 5. For example, in a case that a center point I′k of a region of interest is found by search following an upper point search route, the position of a point J′k=(uk, vk) in the calibration index being displayed on the calibration index display 100 with I′k is (0, d), where the distance between end points of grid points is represented as d, and I′k and J′k arc thus associated with each other.

Likewise, by a lower point search route, a right point search route, and a left point search route, points in the calibration index being displayed on the calibration index display 100 are found at positions (0, −d), (d, 0), (−d, 0), respectively, so that the positions of the detected points are associated with one another.

For I′k that has been associated with a position J′k of a point in the calibration index being displayed on the calibration index display 100, vertically and horizontally adjacent points are repeatedly searched for and associated therewith, and ultimately all I′k are associated with J′k (FIG. 6).

After association of all points has been completed, parameters for distortion calibration are calculated. Representing the position of a point in the calibration index image captured by the imaging section 200 and that displayed on the calibration index display 100 as (x, y), (u, v), respectively, the position relationship between these two points may be expressed as EQs. (5) and (6):

a₁x³+b₁x²y+c₁xy²+d₁y³+e₁x²+f₁xy+g₁y²h₁x+i₁y+j₁=u EQ. (5)

a₂x³+b₂x²y+c₂xy²+d₂y³+e₂x²+f₂xy+g₂y²+h₂x+i₂y+j₂=v EQ. (6)

where a₁, b₁, c₁, d₁, e₁, f₁, g₁, h₁, i₁, j₁, a₂, b₂, c₂, d₂, e₂, f₂, g₂, h₂, i₂, and j₂ are parameters for distortion calibration for figures in the calibration index.

Matrices I′, P, and J′ are defined for I′k and J′k, as follows:

$$\begin{matrix}{I}^{′} = ( \begin{matrix}{x}_{1}^{3} & {x}_{1}^{2} {y}_{1} & {x}_{1} {y}_{1}^{2} & {y}_{1}^{3} & {x}_{1}^{2} & {x}_{1} {y}_{1} & {y}_{1}^{2} & {x}_{1} & {y}_{1} & 1 \\ ⋮ & ⋮ & ⋮ & ⋮ & ⋮ & ⋮ & ⋮ & ⋮ & ⋮ & ⋮ \\ {x}_{n}^{3} & {x}_{n}^{2} {y}_{n} & {x}_{n} {y}_{n}^{2} & {y}_{n}^{3} & {x}_{n}^{2} & {x}_{n} {y}_{n} & {y}_{n}^{2} & {x}_{n} & {y}_{n} & 1\end{matrix} ) & EQ . ( 7 ) \\ {P}^{T} ( \begin{matrix}{a}_{1} & {b}_{1} & {c}_{1} & {d}_{1} & {e}_{1} & {f}_{1} & {g}_{1} & {h}_{1} & {i}_{1} & {j}_{1} \\ {a}_{2} & {b}_{2} & {c}_{2} & {d}_{2} & {e}_{2} & {f}_{2} & {g}_{2} & {h}_{2} & {i}_{2} & {j}_{2}\end{matrix} ) & EQ . ( 8 ) \\ {J}^{′T} = ( \begin{matrix}{u}_{1} & ⋯ & {u}_{n} \\ {v}_{1} & ⋯ & {v}_{n}\end{matrix} ) & EQ . ( 9 )\end{matrix}$$

Then, a matrix P of distortion calibration parameters for a whole captured image can be calculated as EQ. (10) below:

P=(I′^{T}I′)⁻¹I′^{T}J′ EQ. (10)

Alternatively, methods of calculating distortion calibration parameters for a whole captured image that may be employed include a method suitable for input information about positions of lines or figures in the calibration index image captured by the imaging section 200, or a method suitable for input information about positions of lines or figures in the calibration index being displayed on the calibration index display 100 acquired by the correct position acquiring section 500.

The calibrating section 900 (not shown) uses the calculated distortion calibration parameters to calibrate distortion in an image captured by the imaging section 200. It should be noted that the calibrating section 900 may be configured to be provided in the imaging section 200.

Next, an operational procedure for the calibrating system configured as described above will be described according to FIG. 7.

First, the index controller 400 displays a predetermined calibration index on the calibration index display 100 (S101).

Next, the calibration index being displayed on the calibration index display 100 is imaged by the imaging section 200 (S102).

Next, an expected calibration accuracy is calculated by the expected calibration accuracy calculator 300 using the captured calibration index image (S103).

Next, at the index controller 400, a decision as to whether the currently displayed calibration index needs to be modified is made based on the calculated expected calibration accuracy (S104). In a case that the calculation of an expected calibration accuracy at Step S103 is a first pass, this step is skipped and the process goes to Step S105.

In a case that a decision is made that the calibration index needs to be modified, the density of lines or figures constituting the calibration index is modified by the index controller 400, and the modified calibration index is displayed on the calibration index display 100 (S105).

Thereafter, the process goes back to Step S102. On the other hand, in a case that a decision is made that the calibration index does not need to be modified, the calibration index before the last modification is displayed on the calibration index display 100, and information about positions of lines or figures constituting the calibration index is acquired from the index controller 400 by the correct position acquiring section 500 (S106). Then, from the calibration index image captured by the imaging section 200, and the information about positions of lines or figures constituting the calibration index being displayed on the calibration index display 100 acquired by the correct position acquiring section 500, calibration parameters are calculated at the calibration parameter calculator 600 (S106).

By the calibration index evaluating system in accordance with the present embodiment, assuming that figures constituting the calibration index are grid points, for example, a calibration index having a most promising calibration accuracy can be determined while taking account of a tradeoff between the number of grid points and the resolution limit of an imaging device.

While the present embodiment employs the method of modifying the density of lines or figures constituting the calibration index and generating a new calibration index until the calibration index attains an arrangement most suitable for an imaging section, it is possible to employ a method of providing at least one calibration index having a different density of lines or figures constituting the calibration index beforehand, and choosing a most suitable one from among the calibration indices provided beforehand.

Moreover, while in the present embodiment, a configuration for correcting a captured image using calculated calibration parameters is used for explanation, it is possible to employ a configuration in which the calculated calibration parameters arc compared with a threshold to decide whether distortion in the captured image falls within an acceptable range.

As described above, since the present invention can determine a calibration index suitable for each camera, distortion in an image captured by the camera can be corrected with high accuracy.

Since FIG. 17 is similar to FIG. 7 in Steps S101-S106, detailed description thereof will be omitted. A camera is calibrated using the calibration parameters calculated at Step S106.

### Second Embodiment

A configuration of a calibration index evaluating system in accordance, with the present embodiment is shown in FIG. 8.

The calibration index evaluating system is a system for calibrating distortion in a captured image, and comprises a sub-region forming section 700, in addition to the components in the first embodiment.

Specific description will now be made on the expected calibration accuracy calculator 300, index controller 400, and sub-region forming section 700. Since the components other than them perform processing following the description of the first embodiment, detailed description thereof will be omitted.

The expected calibration accuracy calculator 300 calculates a partial expected calibration accuracy for a calibration index image captured by the imaging section 200. The expected calibration accuracy calculator 300 has a calibration index image captured by the imaging section 200 as input, and may be configured by cooperation of predetermined programs and the like stored in a storage device in a computer comprised of a central processing unit (CPU) and storage devices (ROM, RAM, HDD, etc.).

In such a configuration, assuming that figures constituting the calibration index are grid points, for example, binarization and labeling processing are first applied to the calibration index image captured by the imaging section 200, and positions of centers Ik=(ik, jk) (k=0, 1, 2, . . . , n; n is the number of grid points) of grid points on the captured calibration index image are determined. Next, for one grid point, luminance values of pixels are checked starting from the center of the grid point toward the outside of the point. An example of transition of the luminance value here is shown in FIG. 9.

As shown in FIG. 9, from the center to the outside, the luminance value is flat for sometime, then, a change occurs in it near an end point of the circle, and thereafter, the luminance value becomes flat again. The change in luminance value is steeper for a sharper image. The degree of steepness is given to each point to be kept as its information, which serves as a partial expected calibration accuracy. The degree of steepness may be a ratio of the length of a portion having a changing luminance value to the length of a flat portion until a portion with the changing luminance value is reached. Alternatively, the partial expected calibration accuracy may be obtained by using a technique suitable for a calibration index.

The sub-region forming section 700 divides the calibration index image captured by the imaging section 200 into a plurality of sub-regions according to the partial expected calibration accuracy determined by the expected calibration accuracy calculator 300. The sub-region forming section 700 has the partial expected calibration accuracy determined by the expected calibration accuracy calculator 300 as input, and the calibration index image divided into sub-regions as output. The sub-region forming section 700 may be configured by cooperation of predetermined programs and the like stored in a storage device in a computer comprised of a central processing unit (CPU) and storage devices (ROM, RAM, HDD, etc.).

In such a configuration, assuming that the partial expected calibration accuracy is the degree of steepness of the luminance value as described above, for example, contours are generated in a coordinate system that has a plane of the captured image with the expected calibration accuracy in the height direction (FIG. 10).

While methods of generating contours include a method as described in Non-patent Document 1, for example, any other suitable method may be applied.

The contours are generated by, for example, classifying the expected calibration accuracy into several levels.

As an example, referring to FIG. 10, the contours are plotted so that the expected calibration accuracy is classified into three-level sub-regions having 1-3 (low value), 4-7 (modest value), and 8-10 (high value). Moreover, information about the level to which each sub-region belongs is recorded in conjunction. Alternatively, the captured calibration index image may be divided into sub-regions by any technique suitable for a partial expected calibration accuracy determined by the expected calibration accuracy calculator 300.

The index controller 400 uses the calibration index image divided into a plurality of sub-regions by the sub-region forming section 700 to decide whether the calibration index needs to be modified according to an indicator about the expected calibration accuracy in each sub-region, and in a case that a decision is made that the calibration index needs to be modified, modifies the calibration index in the sub-region displayed on the calibration index display 100 according to the expected calibration accuracy. On the other hand, in a case that a decision is made that the displayed calibration index does not need to be modified in the sub-region, the index controller 400 displays the calibration index in the sub-region before the last modification on the calibration index display 100.

The index controller 400 has the calibration index display 100 on its output side, and may be configured by cooperation of predetermined programs and the like stored in a storage device in a computer comprised of a central processing unit (CPU) and storage devices (ROM, RAM, HDD, etc.).

In such a configuration, assuming that the sub-region forming section 700 classifies the partial expected calibration accuracy into three levels of low, modest and high values and divides the image into sub-regions according to the levels, for example, it is decided for a sub-region having a low value that the calibration index in the sub-region needs to be modified, and the density of lines or figures constituting the calibration index in the sub-region is modified to raise the expected calibration accuracy. In particular, assuming that figures constituting the calibration index are grid points, the size of a grid point and the distance between grid points may be increased, that is, the density of grid points may be reduced, for which a method such as one inverting the method in the first configuration may be used.

For a sub-region having a modest value, a decision is made that the calibration index in the sub-region does not need to be modified.

For a sub-region having a high value, a decision is made that the calibration index in the sub-region needs to be modified, and the density of lines or figures constituting the calibration index in the sub-region is modified while preventing lowering of the expected calibration accuracy. In particular, assuming that figures constituting the calibration index are grid points, the size of a grid point and the distance between grid points may be reduced, that is, the density of grid points may be increased, for which a method such as one similar to the method in the first configuration may be used.

In modifying the density of a calibration index in part of the calibration index, a borderline of a sub-region may be prevented from overlapping lines or figures constituting the calibration index for facilitating extraction of the calibration index in image processing. For example, assuming that figures constituting the calibration index are grid points, processing that prevents grid points lying over a borderline of a sub-region from being drawn may be applied (FIG. 11).

Next, an operational procedure for the calibration index evaluating system configured as described above will be described based on FIG. 12.

First, the index controller 400 displays a predetermined calibration index on the calibration index display 100 (S201).

Next, the calibration index being displayed on the calibration index display section 100 is imaged by the imaging section 200 (S202).

After imaging, an expected calibration accuracy is calculated part by part for the captured calibration index image by the expected calibration accuracy calculator 300 (S203), and the calibration index image captured by the imaging section 200 is divided into sub-regions by the sub-region forming section 700 using the partial expected calibration accuracy (S204).

Next, for each divided sub-region, a decision as to whether the calibration index in the sub-region needs to be modified is made at the index controller 400 based on the partial expected calibration accuracy (S205).

In a case that a decision is made that the calibration index in the sub-region needs to be modified, the density of lines or figures constituting the calibration index is modified by the index controller 400 according to the partial expected calibration accuracy, and the modified calibration index is displayed on the calibration index display 100 (S206).

In a case that a decision is made that the calibration index in the current sub-region does not need to be modified, the calibration index before the last modification is displayed on the calibration index display 100. After a decision as to whether the calibration index needs to be modified has been made for all sub-regions, and in a case that there is found at least one sub-region for which a decision is made that the calibration index needs to be modified, the process goes back to Step S202. On the other hand, in a case that there is found no sub-region for which a decision is made that the calibration index needs to be modified, information about positions of lines or figures of the calibration index being displayed on the calibration index display 100 is acquired from the index controller 400 by the correct position acquiring section 500 (S207).

Then, from the information about positions of lines or figures in the calibration index image captured by the imaging section 200 and the information about positions of lines or figures in the calibration index being displayed on the calibration index display 100 acquired by the correct position acquiring section 500, distortion calibration parameters are calculated at the calibration parameter calculator 600 (S208).

By the calibration index evaluating system in accordance with the present embodiment, even in a case that local blurring, which is experienced in inexpensive cameras, is found in an image, the calibration index varying from sub-region to sub-region can be displayed, and calibration parameters can be automatically calculated with good accuracy so that a most promising calibration accuracy can be attained by providing the outlook of local calibration quality for each sub-region.

Since FIG. 18 is similar to FIG. 12 in Steps S201-S208, detailed description thereof will be omitted. A camera is calibrated using the calibration parameters calculated at Step S208.

### Third Embodiment

A configuration of a calibration index evaluating system having a camera calibration performance evaluating section in accordance with the present embodiment is shown in FIG. 13.

The camera calibration performance evaluating system is a system for calibrating distortion in a captured image and evaluating the result.

Since the components other than the calibration performance evaluating section 800 are configured similarly to those in the first or second embodiment, and processing performed has particulars following the description of the first or second embodiment, detailed description thereof will be omitted. Hereinbelow, details of the calibration performance evaluating section 800 will be described.

The calibration performance evaluating section 800 evaluates performance of distortion calibration using distortion calibration parameters for an image calculated by the calibration parameter calculator 600, information about positions of lines or figures constituting the calibration index acquired by the correct position acquiring section 500, and information about positions of lines or figures constituting the calibration index image captured by the imaging section 200.

The calibration performance evaluating section 800 may be configured, for example, by cooperation of predetermined programs and the like stored in a storage device in a computer comprised of a central processing unit (CPU) and storage devices (ROM, RAM, HDD, etc.).

In such a configuration, an exemplary operation of the calibration performance evaluating section 800 will be described based on FIG. 14 assuming that figures constituting the calibration index are grid points.

First, binarization and labeling processing are applied to a calibration index image captured by the imaging section 200 to acquire positions of grid points 10 in the calibration index image captured by the imaging section 200. Next, distortion-calibrated positions of grid points 20 are calculated using distortion calibration parameters calculated by the calibration parameter calculator 600 and the positions of the grid points 10 in the image of the calibration index captured by the imaging section 200. Thereafter, accuracy of distortion calibration is determined using positions of grid points 30 in the calibration index acquired by the correct position acquiring section 500 and the distortion-calibrated positions of the grid points 20.

Moreover, accuracy of distortion calibration may be calculated as follows:

First, the same points in the distortion-calibrated positions of the grid points 20 and the positions of the grid points 30 in the calibration index acquired by the correct position acquiring section 500 are associated with each other. Association of the points may be achieved by the method described in the first embodiment.

Representing ID of the associated point as i, the distortion-calibrated positions of the grid points 20 as (xci, yci), and the positions of the grid points 30 in the calibration index acquired by the correct position acquiring section 500 as (xti, yti), accuracy of distortion calibration A are calculated according to EQ. (11):

$$A = {\sum }_{i}^{n} √ \{ ( xci - xti ) ⋀ 2 + ( yci - yti ) ⋀ 2 \} \qquad EQ . ( 11 )$$

The accuracy A of distortion calibration may be thus calculated using a sum of Euclidean distances; alternatively, it may be calculated using the Manhattan distance or Mahalanobis distance.

Moreover, the resulting value of accuracy of distortion calibration may be used for a purpose of feedback of information about quality of a camera based on the distortion calibration accuracy to a user such that, for example, for a value equal to or greater than a certain value, the value is presented to the user as an acceptable value for distortion, or otherwise, presented to the user as rejected in calibration (a defective).

Next, an example of an operational procedure for the calibration index evaluating system configured as described above will be described based on FIG. 15.

Since Steps S301-S308 are similar to S201-S208 in FIG. 12, detailed description thereof will be omitted. After Step S308, accuracy of distortion calibration is determined by the calibration performance evaluating section 800 and presented to a user (S309).

While FIG. 15 is shown to have a form based on the second embodiment, it may be an operational procedure based on the first embodiment.

By the calibration index evaluating system in accordance with the present embodiment, especially for cameras having a wide range of variation of individual differences in image unsharpness property, calibration of distortion can be performed, and a decision as to whether a certain level of product quality standards is satisfied can be made for presentation to a user.

While the present invention has been described with reference to embodiments and examples in the preceding description, the present invention is not necessarily limited to the embodiments and examples described above; and several modifications may be made within a scope of technical idea thereof.

The present application claims priority based on Japanese Patent Application No. 2008-276675 filed on Oct. 28, 2008, disclosure of which is incorporated herein in its entirety.

### INDUSTRIAL APPLICABILITY

According to the present invention, the distortion calibrating apparatus may be employed as a highly accurate and easy distortion calibrating apparatus for cameras in, for example, lines for producing machinery such as toys, cell phones, and automobiles, especially those equipped with cameras having a wide range of variation of individual differences in image unsharpness property. Moreover, the calibrating system according to the present invention may be employed for the purpose of allowing a camera calibration work, which is generally dealt with in repair services, to be easily made by a user by incorporating the calibrating system into, for example, robots equipped with cameras.

### REFERENCE SIGNS LIST

100 Calibration index display
200 Imaging section
300 Expected calibration accuracy calculator
400 Index controller
401 Calibration index evaluating section
402 Calibration index determiner
500 Correct position acquiring section
600 Calibration parameter calculator
700 Sub-region forming section
800 Calibration performance evaluating section
10 Positions of grid points in calibration index image before distortion calibration
20 Positions of grid points in calibration index image after distortion calibration
30 Positions of grid points in calibration index being displayed on calibration index display

1. A calibration index determining apparatus comprising determiner for providing an evaluation of each calibration index based on a resolution of each calibration index image obtained by imaging a plurality of calibration indices, each composed of at least lines or figures and each having a different size or density of said lines or figures, and determining any one of the calibration indices based on a result of the evaluation.

2. A calibration index determining apparatus according to claim 1, wherein said determiner comprises calibration index generator for generating a calibration index with said size or density modified.

3. A calibration index determining apparatus according to claim 2, wherein said calibration index generator generates a calibration index having sizes or densities varying from region to region within the calibration index.

4. A calibration index determining apparatus according to claim 1, wherein said determiner calculates an expected calibration accuracy, which represents a degree of resolution of lines or figures constituting said calibration index, for each said calibration index image, and determines on said one of a plurality of calibration indices based on said expected calibration accuracy.

5. A calibration index determining apparatus according to claim 4, wherein said determiner calculates said expected calibration accuracy using at least one of the orientation of edges in said lines or figures, intensity of edges, luminance, color information, the number of lines or figures within a defined region.

6. A calibration index determining apparatus according to claim 1, wherein figures constituting said calibration index comprise a checker pattern, figures disposed over grid points, or a rectilinear grid.

7. A calibration index determining apparatus according to claim 6, wherein said calibration index generator modifies at least one of the grid density, the size of figures disposed over grid points, and the thickness of grid lines.

8. A calibration index determining apparatus according to claim 1, comprising calibration parameter calculator for calculating distortion calibration parameters based on positions of lines or figures constituting said determined calibration index, and positions of lines or figures constituting a calibration index in a calibration index image obtained by imaging said determined calibration index.

9. A calibration index determining apparatus according to claim 8, comprising calibration performance evaluating section for evaluating accuracy in distortion correction based on positions of lines or figures constituting said determined calibration index, and positions of lines or figures constituting a calibration index image after correcting a calibration index image obtained by imaging said determined calibration index using said distortion calibration parameters.

10. A calibration index determining apparatus according to claim 8, comprising correcting section for correcting distortion in a captured image using said distortion calibration parameters.

11. A calibrating apparatus comprising calibration parameter calculator for calculating distortion calibration parameters based on positions of lines or figures in a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration indices, and positions of lines or figures in a calibration index on a calibration index image obtained by imaging said determined calibration index.

12. A calibration performance evaluating apparatus comprising calibration performance evaluating section for evaluating accuracy in distortion correction based on positions of lines or figures constituting a calibration index image corrected using a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration index, and positions of lines or figures constituting said determined calibration index.

13. A calibration index determining system comprising determiner for providing an evaluation of each calibration index based on a resolution of each calibration index image obtained by imaging a plurality of calibration indices, each composed of at least lines or figures and each having a different size or density of said lines or figures, and determining any one of the calibration indices based on a result of the evaluation.

14. A calibration index determining method comprising steps of:
providing an evaluation of each calibration index based on a resolution of each calibration index image obtained by imaging a plurality of calibration indices, each composed of at least lines or figures and each having a different size or density of said lines or figures; and
determining any one of the calibration indices based on a result of said evaluation.

15. A calibration index determining method according to claim 14, comprising a step of generating a calibration index with said size or density modified.

16. A calibration index determining method according to claim 15, comprising a step of generating a calibration index having sizes or densities varying from region to region within the calibration index.

17. A calibration index determining method according to claim 14, comprising a step of calculating an expected calibration accuracy, which represents a degree of resolution of lines or figures constituting said calibration index, for each said calibration index image, and determining said one of a plurality of calibration indices based on said expected calibration accuracy.

18. A calibration index determining method according to claim 17, comprising a step of calculating said expected calibration accuracy using at least one of the orientation of edges in said lines or figures, intensity of edges, luminance, color information, the number of lines or figures within a defined region.

19. A calibration index determining method according to claim 14, comprising a step of modifying a checker pattern, figures disposed over grid points, or a rectilinear grid constituting said calibration index in at least one of the density, the size, and the thickness of grid lines.

20. A calibration index determining method according to claim 14, comprising a step of calculating distortion calibration parameters based on positions of lines or figures constituting said determined calibration index, and positions of lines or figures constituting a calibration index in a calibration index image obtained by imaging said determined calibration index.

21. A calibration index determining method according to claim 20, comprising a step of evaluating accuracy in distortion correction based on positions of lines or figures constituting said determined calibration index, and positions of lines or figures constituting a calibration index image after correcting a calibration index image obtained by imaging said determined calibration index using said distortion calibration parameters.

22. A calibration index determining method according to claim 20, comprising a step of correcting distortion in a captured image using said distortion calibration parameters.

23. A program causing a calibration index evaluating apparatus to execute processing of providing an evaluation of each calibration index based on a resolution of each calibration index image obtained by imaging a plurality of calibration indices, each composed of at least lines or figures and each having a different size or density of said lines or figures, and determining any one of the calibration indices based on a result of the evaluation.

24. A program causing a calibrating apparatus to execute processing of calculating distortion calibration parameters based on positions of lines or figures in a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration indices, and positions of lines or figures in a calibration index on a calibration index image obtained by imaging said determined calibration index.

25. A program causing a calibration performance evaluating apparatus to execute processing of evaluating accuracy in distortion correction based on positions of lines or figures constituting a calibration index image corrected using a calibration index obtained by determining any one of calibration indices, each composed of at least lines or figures and each having a different size or density of said lines or figures, based on a result of evaluation of each calibration index based on a resolution of each calibration index image obtained by imaging a plurality of said calibration index, and positions of lines or figures constituting said determined calibration index.
